(19) United States
(12) Patent Application Publication
(10) Pub. No.: US 2025/0034665 A1
(43) Pub. Date: Jan. 30, 2025

(54) CATCHMENT PIT FOR MOLTEN METAL AND COOLANT WATER

(71) Applicants: Erwin SIEGMUND, Oberwoelbling (AT); Martha MUELLNER, Oberwoelbling (AT)

(72) Inventors: Erwin SIEGMUND, Oberwoelbling (AT); Martha MUELLNER, Oberwoelbling (AT)

(21) Appl. No.: 18/760,068

(22) Filed: Jul. 1, 2024

(30) Foreign Application Priority Data
Jul. 25, 2023 (AT) A50596/2023

(51) Int. Cl. C21B 3/00; F27D 21/00

(52) U.S. Cl. CPC C21B 3/00; F27D 21/00; F27D 2021/0071

(57) ABSTRACT

A catchment pit for molten metal and cooling water. has a floor formed with a recess and upwardly open chambers in the pit for receiving the molten metal and supported on the floor. Portions of the side walls of the chambers adjacent respective floors of the chambers and these floors are made of refractory and water-permeable material. A drainage module extends in the pit down into the recess and has a refractory water-permeable side wall so that water in the chambers can pass down into the recess. Granular bulk material fills the pit around and under the chambers and drainage module. A drainage conduit extending down in the drainage module to an intake end in the recess below the chambers. A pump connected to the drainage conduit can thus evacuate water from the recess.

### FIELD OF THE INVENTION

The present invention relates to a catchment pit for catching molten metal and coolant water in the event of a spill in a smelting plant.

### BACKGROUND OF THE INVENTION

A leak or the like in a metal-smelting plant can result in the spilling of molten metal and coolant water. While it is standard to provide a catchment pit at or near a crucible or the like subject to such spillage, it is very important to avoid the explosion created by the instantaneous vaporization of the coolant water by contact with the much hotter molten metal.

To this end the catchment pit is a vessel with a drainage system constructed from granular bulk material, chambers being provided for receiving the molten metal. These chambers are bounded by a floor and side walls that in at least the lower regions of the walls and the floor are formed by a base element made of refractory, water-permeable material.

Such a catchment pit is known from WO 2021/222952 and intended for use with water-cooled melting and holding furnaces in foundries where a spillage can involve quantities of up to around 150 tons and temperatures of up to 1700° C. Therefore, such catchment pits must have a highly refractory lining. They must also be divided into several chambers (up to about 7 tons per chamber) so that the solidified metal in each chamber can be lifted out of the catchment pit individually with a crane after the accident.

To protect against possible explosions when molten metal and water come into contact, the emergency catchment pit must be dry and any contact between the molten metal and any moisture that may occur must be prevented in a suitable manner.

The VDG (Verein Deutscher Gießereifachleute—German Foundrymen's Association) has recognized this and laid down the equipment and properties of emergency catchment pits in the foundry in its Code of Practice S80, August 2007. According to FIG. 1 in the appendix to this publication, the in-situ concrete that forms the base of the catchment pit is first covered with sloping concrete that is inclined toward two water drainage openings, followed by a layer of screened gravel and granulated cupola furnace slag. Cupola slag is very porous and therefore conducts water and water vapor well into the screen gravel layer. On the other hand, cupola furnace slag sinters immediately when it comes into contact with molten metal, making it impermeable and preventing the molten metal from penetrating into the sieve gravel layer.

According to FIG. 1, two filter pipes on the transverse side in the area of the floor of the emergency catchment pit open into a pump shaft or merge into an appropriately dimensioned sewer pipe. The diameter of these filter pipes is usually 100 mm, which results in an area of two times 0.785 dm². Of this, 30% results in a water entry area of two times 0.2355 dm², i.e. around 0.47 dm². According to FIG. 2, only a single water drainage opening is provided on the long side, but this has a larger diameter. According to the above-cited WO 2021/222952 A1, only one drainage pipe is provided.

For practically constant dehumidification to prevent excessive steam development in an emergency, this is a useful value for the VDG's considerations.

In practice, however, it is quite common for emergency collection pits to flood. This may be due to groundwater, surface water as a result of heavy rainfall or a normal burst pipe that remains undetected for a long time. In this case, it is not only necessary to dehumidify, but above to drain it completely. In the case of an emergency catchment pit for 10 tons of liquid iron, this can mean a volume of water including that in the water-permeable partition and surrounding walls of 3 to 5 m³.

However, this quantity cannot drain away through the water drainage openings in a short time. The situation is particularly bad when cupola slag is used under graphite perforated panels, as described in the VDG leaflet S80 cited above. The extremely low permeability for water and water vapor of cupola slag has been a known problem for decades.

However, even in the design according to above-cited WO 2021/222952, large quantities of water cannot drain away in a short time. Although a mass of gravel is very permeable to water, the situation arises that the water can drain relatively quickly through the porous side wall of the chambers into the granular bulk material, but nevertheless water backs up due to the undersized water drainage openings. The intended drainage line only has relatively thin slits to prevent solids from entering the drainage line, and only a small amount of water can flow through these thin slits. The total cross-sectional area of all the slits in the drainage pipe is only around 0.2 dm².

To ensure that this amount of water is removed as quickly as possible so that the melting process does not have to be interrupted, powerful external submersible pumps are usually used to remove the water in several chambers, allowing the water level to fall again due to the communicating chambers. Draining is then continued as described above.

The disadvantage of this is the relatively high cost of the submersible pumps, which have to be set up manually on a site, and also the fact that the submersible pumps cannot pump out the water completely, but only up to a certain minimum level, and the remaining water takes a relatively long time to seep away via the drainage pipe.

### OBJECTS OF THE INVENTION

It is therefore an object of the present invention to provide an improved catchment pit for molten metal and coolant water.

Another object is the provision of such an improved catchment pit for molten metal and coolant water that overcomes the above-given disadvantages, in particular that does not have the above-identified disadvantages.

### SUMMARY OF THE INVENTION

A catchment pit for molten metal and cooling water has according to the invention a floor formed with a recess and upwardly open chambers in the pit for receiving the molten metal and supported on the floor. Portions of the side walls of the chambers adjacent respective floors of the chambers and these floors are made of refractory and water-permeable material. According to the invention a drainage module extends in the pit down into the recess and has a refractory water-permeable side wall so that water in the chambers can pass down into the recess. Granular bulk material fills the pit around and under the chambers and drainage module. A drainage conduit extends down in the drainage module to an intake end in the recess below the chambers. A pump connected to the drainage conduit can thus evacuate water from the recess.

In this case both the material of the side wall of the chambers and the material of the wall of the drainage module should have an open porosity of at least 30%, preferably at least 35%, particularly preferably at least 40%, determined in accordance with EN 993-1. It is particularly favorable if the material is a ceramic foam. A ceramic foam is a solid material that is porous and that sinters on contact with molten iron. In particular, it can be a porous material bonded with calcium aluminate cement that does not undergo post-compaction. The gas permeability Gd of ceramic foam is typically between 1200 and 3000 in the dry state and between 300 and 500 in the wet state.

It is preferred that the drainage module has no bottom, i.e. that the drainage module has a downwardly open lower end, and that this lower end is spaced above the floor of the collection pit in the recess. In this way, water can enter the drainage module both via the wall and via the floor surface and be discharged from there by the pump.

This system has a pump module without a base, whereby the walls preferably have a water permeability of at least 30%. The drain conduit or “pipe” stands on the granular bulk material, e.g. on gravel, in any case at a spacing from the concrete floor of the pit in the recess foundation, so that this floor surface also forms a full water entry surface.

Due to the geometry of the drainage module, this results in an external area with an assumed internal diameter of the chambers of 0.6 m and an assumed height of the chambers of one meter plus a depth of the pump module of 0.5 m, i.e. a water entry area of 0.6 m×π×1.5 m=2.8 m², 30% of which is the open water entry area resulting in 0.85 m², plus the open floor area with (0.6 m/2)²×π=0.28 m² results in a total of 1.13 m² as the effective water entry area. Compared to the current state of the art, this means an increase in the water entry area by a factor of around 240. Even if the pores in the walls are smaller than the gaps in the granular bulk material (gravel), this still results in a larger flow rate. As the lower end of the drainage module is below the lower ends of the chambers, the chambers can be completely drained after flooding and no water remains in the chambers, in contrast to the use of submersible pumps.

It is a particular advantage of the catchment pit is that gravel can be used as drainage material or bulk material; it does not have to be drainage material that sinters on contact with the melt, since the melt cannot come into contact with the bulk material but instead remains in the precast containments. Melt that reaches the bulk material between the containments from above does not penetrate deeply into it, so that it cannot come into contact with water or moisture in the floor area under any circumstances. As gravel is often available on site, this results in a significant cost advantage.

According to one embodiment of the invention, the upper end of the drainage module is above the upper ends of the chambers and/or the dewatering module is closed at the top by a fireproof cover. This prevents liquid metal from entering the dewatering module from above in the event of an accident. This would penetrate unhindered to the granular bulk material (gravel), where water could be present, resulting in a steam explosion. Even if the steam were to escape upward and over the surrounding walls relatively unhindered, i.e. the steam explosion would be relatively harmless, it is preferable to prevent such a steam explosion from occurring in the first place.

### BRIEF DESCRIPTION OF THE DRAWING

The above and other objects, features, and advantages will become more readily apparent from the following description, reference being made to the accompanying drawing in which:

FIG. 1 is a top view of a prior-art catchment pit;

FIG. 2 is a section along line IIBII of FIG. 1 of the prior-art catchment pit;

FIG. 3 is a view like FIG. 1 of the catchment pit according to the invention; and

FIG. 4 is a section along line IVBIV of FIG. 3.

### SPECIFIC DESCRIPTION OF THE INVENTION

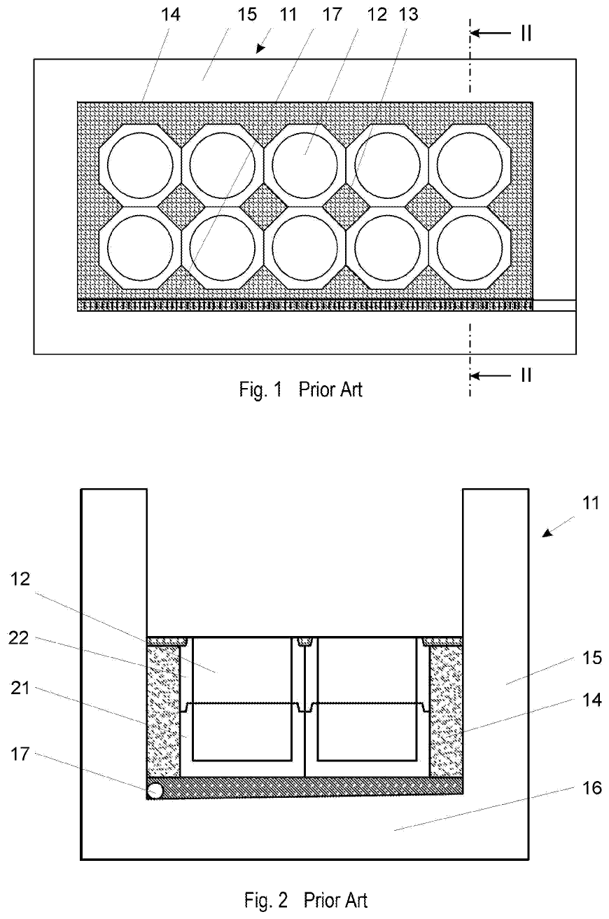

FIGS. 1 and 2 show a catchment pit 11 essentially according to the above-mentioned WO 2021/222952. According to the invention, chambers 12 made of foam ceramic, i.e. made of water- and water vapor-permeable material, are arranged next to each other in the pit 11 that has side walls 15 and a floor 16. Here two rows with five chambers 12 each are provided that are directly next to each other.

The chambers 12 are formed by prefabricated precast containments that are cylindrically round on the inside and octagonal on the outside. This leaves square cavities 13 between the precast containments as seen from above. These cavities 13 and the spaces 14 between them and the walls 15 of the catchment pit 11 are filled with gravel (in the base area) and molded sand (between the walls). At the very top is a thin membrane layer (5-10 cm) of ceramic foam. On the one hand, this makes the surface easier to clean, on the other hand, the molten material does not penetrate any deeper and therefore automatically runs into the chambers 12. However, this is only an example; gravel alone could also be used.

To construct such a catchment pit, a drainage pipe 17 is first laid at the deepest point to drain water to a sump pump. A layer of gravel is then placed on the floor 16, after which the prefabricated containments are placed on this layer of gravel. Finally, the cavities 13 and the space 14 are filled with gravel so that the prefabricated containments are firmly fixed in place.

The idea is to use prefabricated containments with an internal diameter of 600 mm and a height of 1050 mm. Such a prefabricated containment is therefore quite large and weighs over 300 kg, making it difficult to handle. With larger internal diameters of 700 mm or 800 mm, handling is of course even more difficult.

According to WO 2021/222952, the prefabricated containments are each therefore composed of a base element 21 and a standard element 22, each of which has a height of 350 mm. The base elements 21 each have a floor, whereas the standard elements 22 are tubular. The wall thickness is 100 mm to 120 mm, depending on the diameter. In the example shown here, however, the prefabricated containments are made up of one base element 21 and only one standard element 22 and are correspondingly higher. The total height and therefore also the total volume of the individual chambers can be varied by stacking the elements 22 on top of each other (similar to well rings). The space created when several chambers 12 are of modular design is backfilled with gravel with a grain size of 5 mm to 15 mm.

The walls 15 and the floor 16 of the catchment pit are made of concrete reinforced in accordance with the structural requirements. The drainage pipe 17 extends along a longitudinal wall toward the sump pump.

The prefabricated containments are made of ceramic foam and are therefore permeable to water and water vapor as well as being structurally stable. They are arranged in two rows wall to wall.

Due to the fact that the modules are made of ceramic foam, they are porous and water passes through the chambers 12 and subsequently into the gravel floor to the drainage pipe 17 and toward the sump pump. However, when very hot molten metal hits the ceramic foam the pores close and the molten material solidifies inside the chambers 12 after a furnace failure and after the molten material and water have coagulated simultaneously or at intervals into the catchment pit 11. Water vapor escapes through the gravel without pressure build-up. Once the molten mass has solidified, the gravel is removed using an industrial vacuum cleaner. The solidified blocks are then removed with or without the containments and recycled. The gravel can be reused without processing.

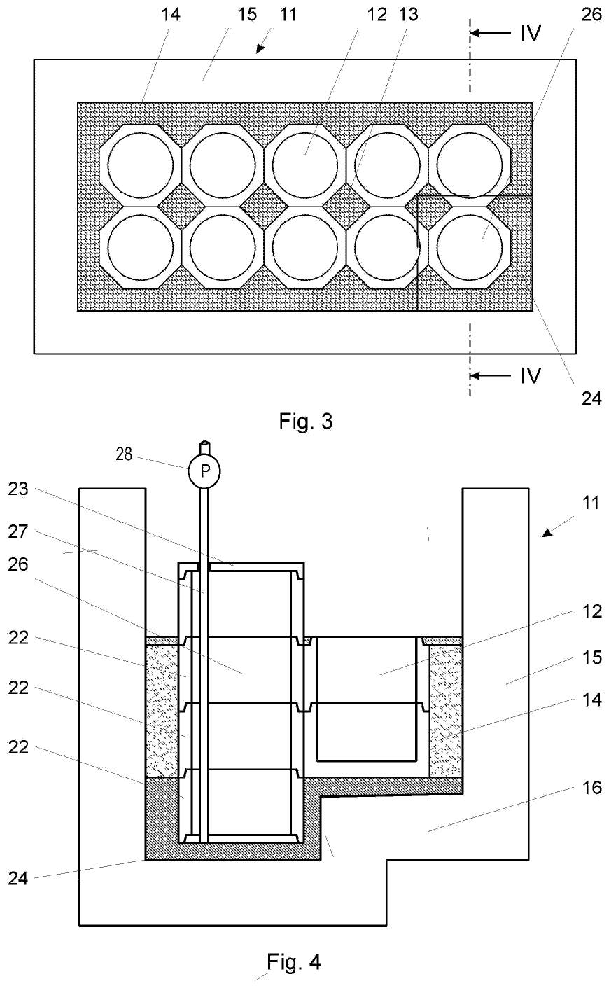

The catchment pit 11 according to the invention (see FIGS. 3 and 4) differs from the known catchment pit 11 in that a drainage module 26 is provided instead of the drainage pipe 17. At the location of the drainage module 26, the floor of the catchment pit 11 has a recess 24 that is lower by the height of a standard element 22 compared to the rest of the floor 16. At this point, a total of four standard elements 22 are placed on the granular fill material. The two middle standard elements 22 are at the same height as the base element 21 and the standard element 22 of the chambers 12, so the uppermost standard element 22 projects upward of the other chambers 12. It is also closed at the top by a cover 23 so that no molten metal can penetrate into the drainage module 26, even in the event of an accident.

A pump 28 is provided in this drainage module 26 to pull water upward out of the drainage module 26 via a line 27. The cover 23 has a corresponding opening for this line 27. However, the pump 28 can also be located outside the dewatering module 26. Preferred are hot water-resistant compressed air diaphragm pumps that are mounted outside the danger zone and draw in water via a 2-inch pipe.

The catchment pit 11 according to the invention can remove the water much faster than the known catchment pit in the event of flooding:

Assuming that the water in all chambers 12 is up to the middle of the standard element 22 of the chambers 12. It is then also at the same height in the drainage module 26, i.e. up to the middle of the third standard element (counted from below) of the drainage module 26.

If the pump is now switched on, the water level in the drainage module 26 drops very quickly, for instance to the top edge of the lowermost standard element 22 of the stack forming the module 26. This results in a very large pressure drop compared to the other chambers 12 where the water is initially still at the same level. The water therefore flows in relatively large quantities per unit of time from the chambers 12 into the drainage module 26, whereas according to the prior art it can only seep away slowly via the drainage pipe 17. Subsequently, the water level in the chambers 12 as well as in the drainage module 26 drops, namely in the drainage module 26 to well below the upper edge of the lowermost standard element 22. This means that a considerable pressure difference (and thus a high water flow) remains even if the water in the chambers 12 is only slightly high. In contrast, the pressure difference between the water in the chambers 12 and the drainage pipe 17 in the known embodiment is already very low at this point, so that the water drains even more slowly than at the beginning.

We claim:

1. A catchment pit for molten metal and cooling water, the pit comprising:
a floor formed with a recess;
upwardly open chambers in the pit for receiving the molten metal and supported on the floor, the chambers having respective floors and side walls, the side walls at least adjacent the respective floors and the floors of the chambers being refractory and water permeable;
a drainage module extending in the pit down into the recess and having a refractory water-permeable side wall, whereby water in the chambers can pass down into the recess;
granular bulk material filling the pit around the chambers and drainage module;
a drainage conduit extending down in the drainage module to an intake end in the recess below the chambers; and
a pump connected to the drainage conduit for evacuating water from the recess.

2. The catchment pit according to claim 1, wherein the side wall of the chambers and side wall of the drainage module have an open porosity of at least 30% determined in accordance with EN 993-1:1995.

3. The catchment pit according to claim 1, wherein the side walls are formed of a ceramic foam.

4. The catchment pit according to claim 1, wherein in the drainage module has a downwardly open lower end in the recess and spaced above the floor of the drainage pit.

5. The catchment pit according to claim 4, wherein the lower end of the drainage module is supported in the recess on the granular bulk material therein.

6. The catchment pit according to claim 4, wherein an upper end of the drainage module is above the chambers.

7. The catchment pit according to claim 6, further comprising:
a cover closing the upper end of the drainage module.

8. The catchment pit according to claim 4, wherein the drainage module is tubular.
